(19) United States
(12) Patent Application Publication
(10) Pub. No.: US 2021/0282233 A1
(43) Pub. Date: Sep. 9, 2021

(54) GLAZING WITH ELECTRICALLY CONDUCTIVE ELEMENT AND ITS ELECTRICAL CONNECTION

(71) Applicant: SAINT-GOBAIN GLASS FRANCE, Courbevoie (FR)

(72) Inventors: Marina BARLET, Compiegne (FR); Richard WOLFF, Pronleroy (FR)

(73) Assignee: Saint-Gobain Glass France, Courbevoie (FR)

(21) Appl. No.: 16/319,597

(22) PCT Filed: Jul. 21, 2017
(86) PCT No.: PCT/FR2017/052026

§ 371 Date: Jan. 22, 2019

(30) Foreign Application Priority Data
Jul. 22, 2016 (FR) 1656999

(51) Int. Cl. H05B 3/84; H05B 3/06

(52) U.S. Cl. CPC H05B 3/84; H05B 2203/013; H05B 2203/011; H05B 3/06

(57) ABSTRACT

A glazing includes a glazing substrate including an electrically conductive element and a through-orifice located in proximity to the electrically conductive element; and a first electrically connecting part that is associated with the conductive element and intended to be associated, in particular via a male-female interaction, with a second electrically connecting part, the first electrically connecting part making electrical contact with the electrically conductive element and being engaged in the orifice of the glazing, and the first electrically connecting part including a flat head that is in intimate contact against the electrically conductive element, and a cylindrical body that is engaged in the orifice, the cylindrical body being threaded or tapped.

The invention relates to the electrical connection of a glazing including at least one electrically conductive element to be supplied with power.

The invention will more particularly be described with regard to a heated glazing, without however being limited thereto. The invention applies to any glass substrate or glazing equipped with at least one electrically conductive element (electrically conductive layer, electrically conductive strip, etc.) having to be electrically connected to a power supply, whatever the application of the glazing.

A heated glazing is a glazing comprising electrically conductive means on one of its faces, which means, when they are subjected to an electrical current, allow the temperature of the glazing to be raised. This type of glazing may be used, in means of transport or even in the building industry, to prevent or eliminate the formation of condensation or frost on the glazing, or to prevent it from feeling cold to the touch, or indeed to form, as such, a heater.

As is known, the electrically conductive means of a heated glazing may for example consist of metal wires screen printed on the glass or of metal wires securely fastened to the plastic film of a laminated glazing, or of a thin layer of one or more metal oxides deposited on the glass, which layer may furthermore be low-E. The electrically conductive heating means are generally connected to an electrically connecting collector strip made of copper or of a metal material formed from a silver paste.

The heating means are supplied with electrical power via a connecting interface allowing the metal collector strip, which is internal to the glazing, to be electrically connected to electrical cables and/or lugs that are external to the glazing and that are associated with said connecting interface when they are added.

At the present time, the electrically connecting interface between the conductive elements internal to the glazing and the external electrical power supply, such as at least one electrical wire, is achieved by soldering, or by male and female interface parts that are plugged into each other, one being associated with the conductive element of the glazing whereas the other is associated with the external power supply.

However, to form an extremely good solder-based connection requires attention to detail and time. Furthermore, if the glazing is laminated and protrusions are present level with the one or more plastic sheets of the laminate, there is a high risk that bubbles will be created during the soldering, possibly initiating delamination.

With regard to an electrical connection via male-female parts, it is necessary to guarantee a reliable electrical connection with a zero risk of untimely detachment of the parts.

Therefore, the aim of the invention is to provide a glazing equipped with an electrical connection that does not have the drawbacks of the prior art, as its electrical connection is reliable and durable, and a simple and inexpensive manufacturing and implementing process.

According to the invention, the glazing includes at least:
one glazing substrate including an electrically conductive element and a through-orifice located in proximity to the electrically conductive element; and
one first electrically connecting part that is associated with the conductive element and intended to be associated, in particular via a male-female interaction, with a second electrically connecting part,

the first electrically connecting part on the one hand making electrical contact with the electrically conductive element and on the other hand being engaged in the orifice of the glazing, and the first electrically connecting part comprising a flat head that is in intimate contact against the electrically conductive element, and a cylindrical body that is engaged in the orifice, the cylindrical body being threaded or tapped.

Thus, the electrical connection proposed by the invention involves no soldering, is easy to install, ensures a reliable and durable contact with the conductive element, and is small in bulk. Furthermore, it is removable, making it uninstallable if necessary, for example if the glazing must be uninstalled with regard to its final use, or if electrical checks must be carried out on the glazing or electrical power supply, allowing the electrical supply cables to be rapidly disassociated.

In the rest of the description, the terms “external” and “internal” will be understood as qualifying elements located on or against the exterior of the glazing, and in the glazing when the latter is laminated, respectively.

According to one feature, the glazing furthermore includes the second electrically connecting part which is fitted into or around the first part by screwing, the second part having a tapped body if the body of the first part is threaded, or a threaded body if the body of the first part is tapped.

According to another feature, the first electrically connecting part optionally protrudes from the orifice on the exterior of the glazing.

In one embodiment, when the cylindrical body of the first part is tapped or threaded, the free end of said cylindrical body, opposite the flat head, protrudes beyond a face of the glazing substrate.

In another embodiment, when the cylindrical body of the first part is tapped, the free end of said cylindrical body, opposite the flat head, does not protrude beyond a face of the glazing substrate.

Advantageously, the flat head of the first part has a thickness of about 0.1 mm for a plastic interlayer film of 0.38 mm thickness, or a thickness smaller than 0.5 mm, and preferably a thickness smaller than 0.4 mm, for a laminated glazing comprising two glazing substrates of 4 mm thickness and an interlayer sheet of 0.76 mm thickness.

Moreover, the interlayer film may be a monolayer or multilayer film.

According to another feature, when the glazing includes the second electrically connecting part, the second electrically connecting part furthermore includes a head (end opposite the end interacting with the first part) the cross-sectional area of which is larger than the cross-sectional area of the cylindrical body of said second part, so as to form an abutment intended to sandwich an electrical lug between said head of the second electrically connecting part and the body of the first electrical part and/or the glazing substrate (the external face of the glazing).

Specifically, the glazing includes at least one electrical lug equipped with a hole and associated with the pair formed by the two electrically connecting parts.

Depending on the dimensions of the hole of the electrical lug and those of the cylindrical bodies of the electrically connecting parts, the arrangement of the lug at the interface is different. Two variants are thus envisionable:
the cylindrical body of the first electrically connecting part projects out of the orifice of the glazing and the electrical lug is placed on the end face of the free end of the body of the first part; or else
the electrical lug is equipped with a hole and is slipped, via its hole, around the cylindrical body of the second connecting part, irrespectively of whether the first electrically connecting part does or does not protrude from the glazing.

Advantageously, the glazing furthermore includes at least one washer, which is preferably split to facilitate its assembly, that is associated sandwiched between the head of the second connecting part and the glazing substrate(the external face of the glazing) in order to compensate for deformation due to any relaxation of the assembled parts after tightening.

Preferably, the first and second electrically connecting parts are made of brass and/or copper.

According to another feature, the second electrically connecting part is intended to be screwed with the first part by means of a torque screwdriver in order to guarantee an ad hoc pressure against the glass in order to prevent any crack initiation.

In one preferred embodiment, the glazing is laminated. The glazing furthermore includes at least one second glazing substrate and an interlayer film that is arranged sandwiched between the glazing substrates in order to form a laminated glazing, said at least electrically conductive element being placed on an internal face of one of the glazing substrates, the head of the first electrically connecting part being in intimate contact against the conductive element, and the plastic film covering the head of said first connecting part, opposite the electrically conductive element.

According to another feature, the conductive element is a localized means, located on the glazing, for distributing current to the glazing when the latter requires a supply of electrical power, in particular the localized means for distributing current is an electrically conductive strip that is securely fastened to a heating element of the glazing when the glazing is a heated glazing.

In one particular application of the glazing, when the glazing is heated, the heating element of the glazing is preferably an electrically conductive layer and the conductive element, which forms at least one means for distributing electrical current, is an electrically conductive strip, such as one made of silver paste or of copper, that is securely fastened to the layer and against which the head of the first electrically connecting part of the electrically connecting means of the invention makes contact.

For a heated glazing, two spaced-apart pairs of two electrically connecting parts according to the invention are more particularly used in order to supply two conductive collectors.

The glazing may of course be intended for any application other than a heated-glazing application and relates to any glazing requiring a supply of electrical power.

The invention also relates to a process for manufacturing a laminated glazing according to the invention, and comprising the following steps:
providing a first glazing substrate equipped with at least one electrically conductive element;
drilling at least one through-orifice in the glazing substrate;
positioning the first electrically connecting part in the orifice;
holding said first electrically connecting part in position so that its head bears against the conductive element, preferably by fitting by screwing the second electrically connecting part on the first electrically connecting part;
providing and positioning a PVB (polyvinyl butyral) or EVA (ethylene vinyl acetate) interlayer film on the substrate so as to cover the head of the first electrically connecting part;
providing and positioning a second glazing substrate against the interlayer film and assembling the glazing substrates and the interlayer film in a conventional way in order to produce a laminated glazing; and
if it has not already been done, fitting by screwing the second electrically connecting part into the first electrically connecting part, there optionally having been arranged, at the interface thereof, an electrical lug equipped with electrical power cables.

The present invention will now be described by way of solely illustrative examples that in no way limit the scope of the invention, and with reference to the appended drawings, in which:

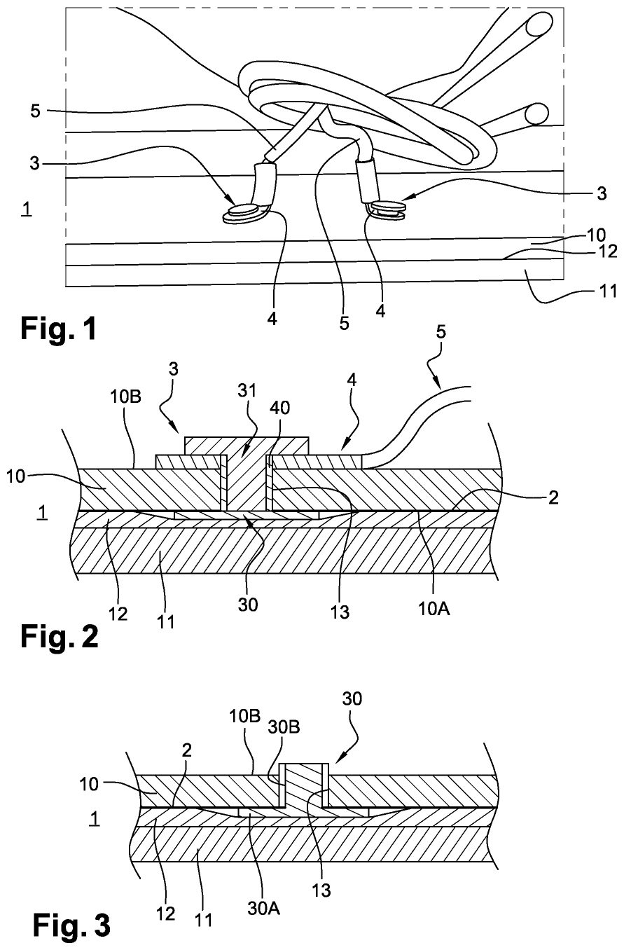

FIG. 1 shows a partial downward perspective view of a glazing of the invention, which glazing is equipped with two electrically connecting means connected to electrical cables;

FIG. 2 is a schematic view of a cross section through the thickness of the glazing of FIG. 1, illustrating the two parts associated with one of the electrically connecting means of the invention;

FIG. 3 corresponds to FIG. 2 but only shows the first part of the electrically connecting means, which part is securely fastened to the glazing;

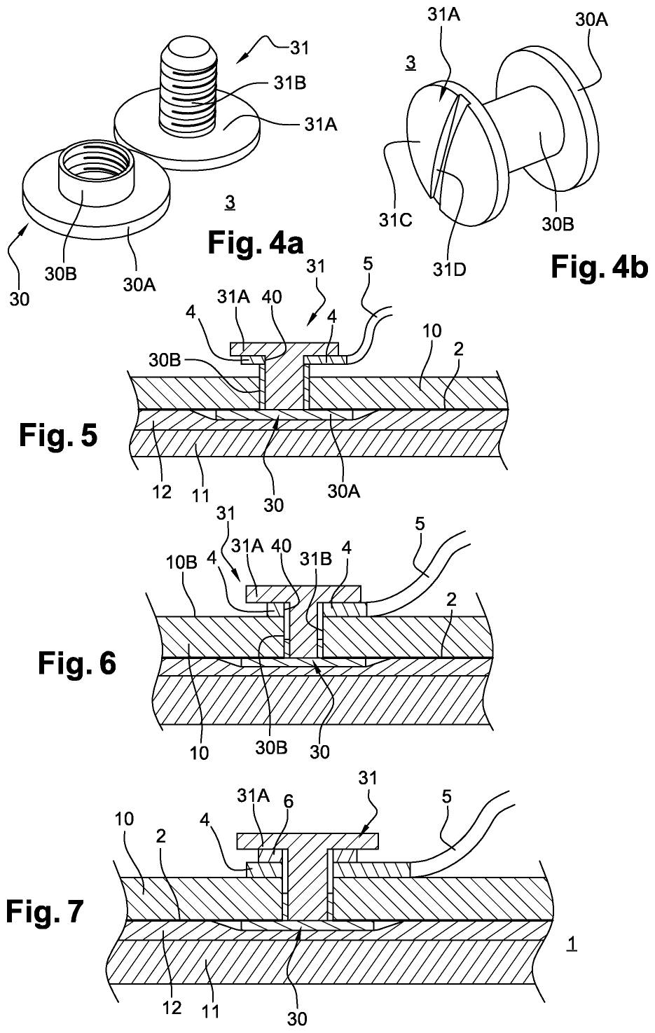

FIGS. 4a and 4b illustrate one embodiment of the electrically connecting means of the glazing of FIG. 1 and show the two parts separate and assembled, respectively;

FIGS. 5 and 6 are schematic cross-sectional views of two respective variant ways in which an electrical lug may be associated with the parts of the electrically connecting means of the invention; and

FIG. 7 corresponds to FIG. 2, the electrically connecting means including an interface washer for the tightening.

The figures are not to scale for the sake of legibility.

The glazing 1 illustrated in FIGS. 1 to 3 is a laminated glazing according to the invention comprising at least one electrically conductive element 2 such as, for example, an electrically conductive strip of the type made of silver, which is for example securely fastened to an electrically conductive heating layer covering one of the faces of the glazing, and electrically connecting means 3 for supplying electrical power to the electrically conductive element 2, said connecting means being shown in isolation in FIG. 4a.

The targeted application of the glazing is, by way of example, described for a heated glazing, but is completely nonlimiting.

The electrically connecting means 3 shown in FIG. 1 are identical and two in number in order to form the positive and negative poles of the electrical power supply of the electrically conductive element 2.

The electrically connecting means 3 are associated with electrical supply cables 5 via electrical lugs 4.

The laminated glazing 1 includes two glazing substrates 10 and 11 sandwiching a plastic interlayer film 12. At least one of the internal faces of one of the substrates, for example the internal face 10A of the substrate 10, includes the electrically conductive element 2.

The glazing includes a through-aperture 13 in one of the glazing substrates, here the substrate 10 equipped with the electrically conductive element 2.

The electrically connecting means 3 include two electrically connecting parts 30 and 31 that mutually interact via a male-female type interaction.

According to the invention, the two electrically conductive connecting parts 30 and 31 interact by screwing.

One of the parts, the first part 30, is securely fastened to the glazing (FIG. 3), whereas the second part 31 is removably assembled and fitted into the first part.

With regard to FIGS. 4a and 4b, the first part 30 includes a flat head 30A and a cylindrical body 30B that extends perpendicularly to the plane of the head 30A, said cylindrical body 30B being tapped. The second part 31 includes a head 31A, which is preferably flat, and a threaded cylindrical body 31B extending perpendicularly to the plane of the head 31A. The internal and external thread are configured to interact together by screwing to form the assembly of FIG. 4b.

As a variant, the cylindrical body of the first part could be threaded whereas the cylindrical body of the second part could be tapped.

The external surface 31C of the head 31A of the second part 31, i.e. the surface opposite the cylindrical body, includes a groove 31D in order to allow the part to be screwed via a screwdriver. Preferably, the screwing is carried out via a torque screwdriver in order to control the clamping force against the glass.

The two electrically connecting parts 30 and 31 are made of an electrically conductive material, such as a metal, and for example of brass or copper.

With regard to FIG. 3, the first part 30 is intended to be associated with the substrate 10 of the glazing equipped with the electrically conductive element 2. The head 30A is held flat against the electrically conductive element 2 in direct and intimate contact. The cylindrical body 30B is engaged in the orifice 13 of the substrate 10 and opens onto the external face 10A of the substrate. The orifice 13 has a cross-sectional area suitable for receiving the cylindrical body snugly but preventing the latter from exerting pressure on the walls of the orifice.

Before engagement of the second part 31 in the first part, an electrical lug 4 that is securely fastened to electrical cables 5 is associated with the cylindrical body of either part (FIG. 2 and FIG. 6). The electrical cables 5 deliver electrical power.

The electrical lug 4 is used because it is a very commonplace electrically connecting means that is easy to use. Other electrically connecting means could be used.

The lug 4 is flat and equipped with a hole 40. The lug 4 is sandwiched between the head 31A of the second part 31 and either the glazing as illustrated in FIG. 2, or the free end of the first connecting part 20 as illustrated in the variant of FIG. 5.

Depending on the size of the hole of the lug and whether or not the cylindrical body 30B of the first connecting part 31 protrudes with respect to the external face 10B of the glazing, a plurality of variant associations are envisionable.

In the variant of FIG. 2, the first connecting part 30 protrudes with respect to the external face 10B of the glazing substrate 10 and the lug 4 is engaged via its hole 40 around the free end of the cylindrical body 30B of the first connecting part 30. The second part 31 is screwed into the cylindrical body 30B of the first part 30, the head 31A of said second part clamping the lug 4 against the external face 10B of the glazing.

Current is passed via the lug 4 then via the cylindrical body 30B of the first connecting part 30 to the head 30A of the first part making contact with the conductive element 2.

In the variant of FIG. 5, the cylindrical body 30B of the first connecting part 30 protrudes beyond the external face 10B of the glazing and the lug 4 rests on the end face of the free end of said cylindrical body 30B of the first connecting part 30. The second part 31 is screwed into the cylindrical body 30B of the first part 30, the head 31A of said second part clamping the lug 4 against the end face of the free end of the cylindrical body 30B of the first connecting part 30. Electrical current is then intended to pass via the lug 4 then via the cylindrical body 30B of the first connecting part 30 to the head 30 of said first part 30 making contact with the conductive element 2.

In the variant of FIG. 6, the cylindrical body 30B of the first connecting part 30 does not protrude beyond the face 10B of the glazing, and the lug 4 is placed via its hole 40 around the cylindrical body 31B of the second part 31 and in abutment with the head 31A of said second part. The second part 31 is screwed into the cylindrical body 30B of the first part 30, the head 31A of said second part clamping the lug 4 against the external face 10B of the substrate 10 of the glazing. Current is then channeled from the lug 4, then along the cylindrical body 31B of the second part 31 in order to pass, via the cylindrical body 30B of the first part 30, to its head 30A making contact with the conductive element 2.

The following is the manufacturing process of the glazing:
the orifice 13 is produced in the glazing substrate 10 equipped with the conductive element 2 to be supplied with power;
the glazing substrate 10 is arranged on a holder, the external face turned downward whereas the internal face 10A equipped with the conductive element 2 is turned upward;
the first part 30 is added to the glazing by inserting its cylindrical body 30B into the orifice 13, the head 30A resting on the internal face 10A equipped with the conductive element 2;
the second connecting part 31 is screwed from below into or around the first connecting part 30 in order to maintain the head 30A of the first connecting part in place and clamped in intimate contact with the conductive element 2;
the interlayer film 12 is added to the internal face 10A of the glazing bearing the conductive element 2, then the second glazing substrate 11 is deposited from above;
the resulting assembly is passed through an oven or autoclave (depending on the nature of the interlayer) to form the laminated glazing, the first part 30 being assembled and definitively fastened in the glazing. FIG. 3 illustrates the laminated glazing with the securely fastened first connecting part 30, the removable second connecting part 31 having been unscrewed and removed.

To install the glazing and to connect it to an electrical power supply. It is recommended beforehand to unscrew the removable second connecting part 31 and to remove it. Next, the lug 4 equipped with supply cables 5 is associated with the cylindrical body 30B of the first connecting part 30 or indeed with the cylindrical body 31B of the second connecting part 30.

Lastly, the removable second part 31 is screwed back into or onto the securely fastened first part 30 and preferably tightened with a controlled torque.

In one preferred variant, which is illustrated in FIG. 7, a washer 6 is associated between the head 31A of the second part 31 and the lug 4 in order to guarantee mechanical contact by compensating for any loosening over time (similarly to a spring). The washer is preferably split in order to facilitate its association with the cylindrical body.

1. A glazing comprising:
a glazing substrate including an electrically conductive element and a through-orifice located in proximity to the electrically conductive element; and
a first electrically connecting part that is associated with the electrically conductive element and adapted to be associated with a second electrically connecting part,
the first electrically connecting part making electrical contact with the electrically conductive element and being engaged in the through-orifice of the glazing, and the first electrically connecting part comprising a flat head that is in intimate contact against the electrically conductive element, and a cylindrical body that is engaged in the through-orifice, the cylindrical body being threaded or tapped.

2. The glazing as claimed in claim 1, further comprising the second electrically connecting part which is fitted into or around the first electrically connecting part by screwing, the second electrically connecting part having a tapped body when the cylindrical body of the first electrically connecting part is threaded, or a threaded body when the cylindrical body of the first electrically connecting part is tapped.

3. The glazing as claimed in claim 1, wherein, when the cylindrical body of the first electrically connecting part is tapped or threaded, the a free end of said cylindrical body, opposite the flat head, protrudes beyond a face of the glazing substrate.

4. The glazing as claimed in claim 1, wherein, when the cylindrical body of the first electrically connecting part is tapped, a free end of said cylindrical body, opposite the flat head, does not protrude beyond a face of the glazing substrate.

5. The glazing as claimed in claim 1, wherein the flat head of the first electrically connecting part has a thickness of about 0.1 mm for a plastic interlayer film of 0.38 mm thickness, or a thickness smaller than 0.5 mm for a laminated glazing comprising two glazing substrates of 4 mm thickness and an interlayer sheet of 0.76 mm thickness.

6. The glazing as claimed in claim 1, wherein, when the glazing includes the second electrically connecting part, the second electrically connecting part further includes a head of larger cross-sectional area than a cross-sectional area of the cylindrical body so as to form an abutment intended to sandwich an electrical lug between said head of the second electrically connecting part and the cylindrical body of the first electrically connecting part and/or the glazing substrate.

7. The glazing as claimed in claim 6, wherein the cylindrical body of the first electrically connecting part projects out of the through-orifice of the glazing and the electrical lug is placed on an end face of a free end of the cylindrical body of the first electrically connecting part.

8. The glazing as claimed in claim 6, wherein the electrical lug is equipped with a hole and is slipped, via its hole, around the cylindrical body of the second electrically connecting part.

9. The glazing as claimed in claim 6, further comprising at least one washer that is associated sandwiched between the head of the second electrically connecting part and the glazing substrate.

10. The glazing as claimed in claim 1, wherein the first and second electrically connecting parts are made of brass and/or copper.

11. The glazing as claimed in claim 1, wherein the second electrically connecting part is adapted to be screwed with the first electrically connecting part by means of a torque screwdriver.

12. The glazing as claimed in claim 1, further comprising at least one second glazing substrate and an interlayer film that is arranged sandwiched between the glazing substrates and the at least one second glazing substrate in order to form a laminated glazing, the electrically conductive element being placed on an internal face of one of the glazing substrates and the at least one second glazing substrate, the head of the first electrically connecting part being in intimate contact against the electrically conductive element, and the interlayer film covering the head of said first electrically connecting part, opposite the electrically conductive element.

13. The glazing as claimed in claim 1, wherein the electrically conductive element is a localized means, located on the glazing, for distributing current to the glazing when the glazing requires a supply of electrical power.

14. A process for manufacturing a glazing as claimed in claim 1, comprising:
providing a first glazing substrate equipped with at least one electrically conductive element;
drilling at least one through-orifice in the first glazing substrate;
positioning the first electrically connecting part in the at least one through-orifice;
holding said first electrically connecting part in position so that its head bears against the electrically conductive element;
providing and positioning an interlayer film on the substrate so as to cover the head of the first electrically connecting part;
providing and positioning a second glazing substrate against the interlayer film and assembling the first and second glazing substrates and the interlayer film in a conventional way in order to produce a laminated glazing; and
if when it has not already been done, fitting by screwing the second electrically connecting part into the first electrically connecting part there optionally having been arranged, at the interface thereof, an electrical lug equipped with electrical power cables.

15. The glazing as claimed in claim 1, wherein the first electrically connecting part is adapted to be associated via a male-female interaction with the second electrically connecting part.

16. The glazing as claimed in claim 5, wherein the flat head of the first electrically connecting part has a thickness smaller than 0.4 mm for a laminated glazing comprising two glazing substrates of 4 mm thickness and an interlayer sheet of 0.76 mm thickness.

17. The glazing as claimed in claim 13, wherein the localized means is an electrically conductive strip that is securely fastened to a heating element of the glazing when the glazing is a heated glazing.

18. The process as claimed in claim 14, wherein said first electrically connecting part is held in position so that its head bears against the electrically conductive element by fitting by screwing the second electrically connecting part on the first electrically connecting part.
